(19) United States
(12) Patent Application Publication
(10) Pub. No.: US 2004/0045187 A1
(43) Pub. Date: Mar. 11, 2004

(54) Heatless and reduced-heat drying systems

(75) Inventors: John Michael Curry, Plano, TX (US); Troy Inslee Vanderhoof, Plano, TX (US); Brian Douglas Cross, Double Oak, TX (US)

Correspondence Address: WOOD, HERRON & EVANS, LLP, 2700 CAREW TOWER, 441 VINE STREET, CINCINNATI, OH, 45202, US

(73) Assignee: Andrew Corporation, Orland Park, IL (US)

(21) Appl. No.: 10/238,503

(22) Filed: Sep. 10, 2002

(51) Int. Cl. F26B 11/02

(52) U.S. Cl. 34/595; 34/254

(57) ABSTRACT

Apparatus and method for drying articles either free of applied heat or with a significantly reduced heating requirement. The apparatus includes a drying gas source is operative to dehumidify a moisture-laden gas, such as ambient air, flowing in the flow path to provide a drying gas to a drying chamber of a receptacle holding the articles. The drying gas removes moisture, or other cleansing liquid, from articles held in the chamber. The drying gas and moisture entrained in the drying gas are exhausted from the receptacle. The apparatus may optionally be equipped to provide a cleansing liquid, such as water, to the receptacle for mixing with the articles before the drying gas is supplied.

### FIELD OF THE INVENTION

This invention relates generally to drying systems and, in particular, to drying systems that remove moisture from moist or wetted articles with either non-heated air or air heated to a reduced temperature.

### BACKGROUND OF THE INVENTION

Conventional drying systems, such as for use to dry items including clothing, are of the once-through external air type. In such systems, the ambient air is heated with a heater, usually by exposing a forced flow of ambient air or other gas to heat generated by a gas heating box or an electric heating element. An air plenum conveys the heated drying air into a chamber enclosed within a tumbler drum. A load of water-impregnated articles is carried within the tumbler drum, which is rotated such that the articles will be tumbled while heated drying air flows through the drum. A full load of wet articles, particularly absorbent articles, may contain one to one and a half gallons of water that must be extracted. The heated drying air elevates the temperature of the articles and the water held by the articles. The heated water evaporates and is entrained in the heated air. The spent hot, moisture-laden air is discharged from the dryer. The discharge air path is typically vented to the outside of the building in which the dryer is positioned.

Conventional dryers equipped with a conventional heater for heating the drying air suffer from multiple deficiencies. Foremost among these deficiencies is that the primary energy consumption associated with the dryer arises from powering the heater. In addition, the heat transfer from the heater to the flowing air is relatively inefficient in that significant heat energy is wasted. Another deficiency is that the heat transferred from the heated air may deteriorate the articles in some way and, as a result, reduces their lifetime. Furthermore, certain articles, such as fabric articles, are prone to shrinkage when exposed to elevated temperatures. Yet another deficiency of conventional dryers is that the heater provides a significant fire or flammability hazard.

Similar to the operation drying systems used for fabric articles, other drying systems rely on a flow of a heated air or gas to a stationary chamber for removing moisture from moist or wetted articles. For example, the semiconductor packaging industry utilizes aqueous washing to remove solder flux residues from assembled dies and substrates. After washing, a heated stream of air is used to remove residual water from the surfaces of the assembly. Yet another drying system that relies on heated air for water removal is a dishwasher. At the end of a washing cycle of a dishwasher, residual water left on the dishes is evaporated by heating the residual water to a temperature greater than the dew point temperature of the air in the dishwasher chamber.

Therefore, it would be desirable to have a drying system that has reduced reliance on a heavy flow of heated air for removing the moisture from the articles being dried. Furthermore, it is desirable to significantly reduce or even eliminate the reliance of a drying system on any heat source. It is further desirable to reduce the detrimental effects of heat on the articles being dried.

### BRIEF DESCRIPTION OF THE DRAWINGS

FIG. 1 is a diagrammatic perspective view of a dryer in accordance with principles of the invention;

FIG. 2 is a diagrammatic view of an embodiment of the dryer of FIG. 1 in accordance with principles of the invention;

FIG. 3 is a diagrammatic view of another embodiment of the dryer of FIG. 1 in accordance with principles of the invention;

FIG. 4 is a diagrammatic view of another embodiment of the dryer of FIG. 1 in accordance with principles of the invention;

FIG. 5 is a diagrammatic view of another embodiment of the dryer of FIG. 1 in accordance with principles of the invention; and

FIG. 6 is a diagrammatic view of another embodiment of the dryer of FIG. 1 in accordance with principles of the invention.

### DETAILED DESCRIPTION OF THE INVENTION

Although the invention will be described next in connection with certain embodiments, the invention is not limited to practice in any one specific type of drying system or dryer. It is contemplated that the invention can be used with a variety of drying systems, including but not limited to dryers for fabric articles or clothes dryers. Exemplary clothes dryers in which the principles of the invention can be used are commercially available, for example, from Maytag Corporation (Newton, Iowa), General Electric Company (Louisville, Ky.), Whirlpool Corporation (Benton Harbor, Ml), and Sears, Roebuck and Co. (Hoffman Estates, Ill.) and such commercially available clothes dryers can be adapted to include a drying system constructed in accordance with the present invention. It is appreciated that the drying systems of the invention may be used to dry other moist or wetted articles, such as dishes or electronic and semiconductor components, or any other washed or wetted components or articles that require active drying. The description of the invention is intended to cover all alternatives, modifications, and equivalent arrangements as may be included within the spirit and scope of the invention as defined by the appended claims. In particular, those skilled in the art will recognize that the components of the invention described herein could be arranged in multiple different ways.

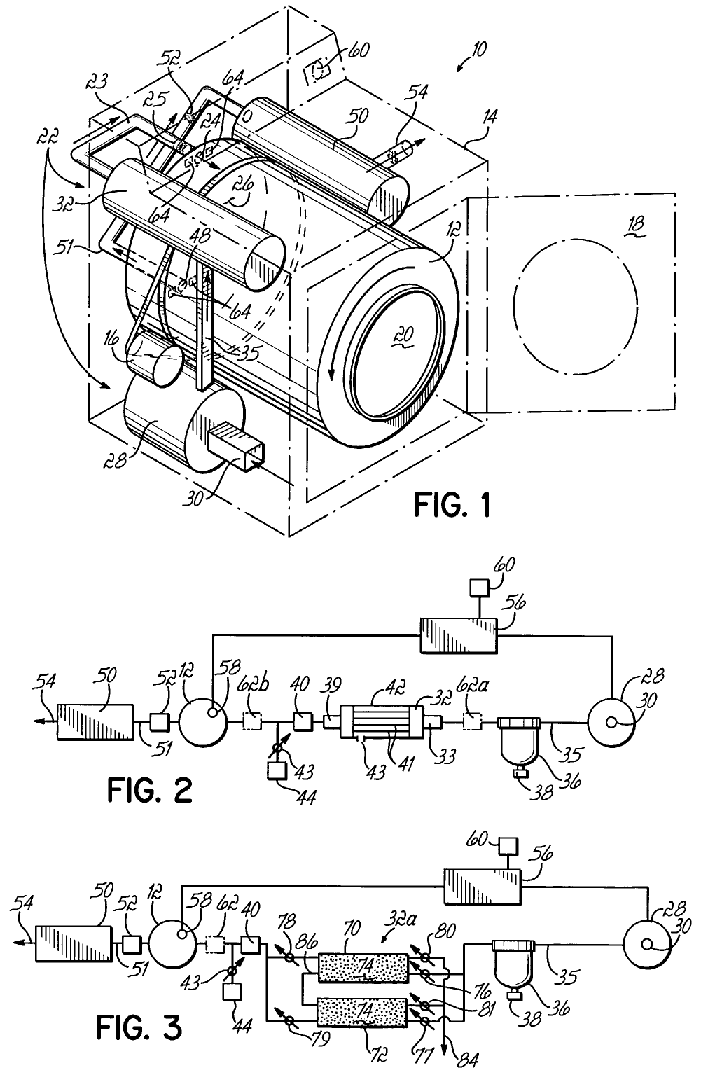

With reference to FIGS. 1 and 2, a dryer 10 according to the principles of the invention includes an open-ended receptacle 12 rotatably disposed within an outer cabinet 14 consisting of a metal sheet housing attached to a rigid support frame. The receptacle 12 is rotated, when the dryer 10 is operating, by a motor 16 mechanically coupled with drum 12 by a drive mechanism for rotating the receptacle as understood by those of ordinary skill. A cabinet door 18 is pivotally movable between an open position permitting delivery of articles to be dried and a closed position when the dryer 10 is operating. In the open position, the cabinet door 18 provides access to a chamber 20 provided inside the receptacle 12. The chamber 20 is adapted to accept wet or moist articles. In the closed position, a resiliently compressible sealing gasket (not shown) is captured between a portion of the outer cabinet 14 and an outer periphery of the cabinet door 18.

A dehumidifying system, generally indicated by reference numeral 22, is located inside the outer cabinet 14. The dehumidifying system 22 is coupled in fluid communication with chamber 20 by an air passageway 23 with an inlet 24 provided in a stationary rear wall 26 of receptacle 12. The dehumidifying system 22 includes a compressor 28 that intakes moisture-laden ambient air having the characteristics (i.e., dew point or relative humidity, temperature, etc.) of the surrounding environment through an air intake 30 and a dehumidifier 32 having an inlet port 33 coupled in fluid communication by an air passageway 35 with an outlet of the compressor 28. It is appreciated that the compressor 28 may supply a flow of a moisture-laden gas other than ambient air to the dehumidifier 32. The use of the terms “air” and “gas” with respect to the drying air or drying gas are used synonymously herein. A pre-filter 36 in air passageway 35 removes particulate matter and moisture, usually in the form of relatively-large entrained condensed droplets, from the air stream provided by compressor 28. A drain 38 is provided for exhausting the accumulated moisture from the pre-filter 36.

According to the principles of the invention, the dehumidifier 32 is operative for removing moisture from the flow of ambient air or gas supplied by the compressor 28 so as to significantly reduce the relative humidity of the ambient air provided to inlet 24 and to provide an output stream of drying air from an outlet port 39. The drying air is significantly dehumidified for removing residual cleansing liquid, such as moisture, from the articles held within the receptacle 12. The drying air is depleted of water molecules and, as a result, has a significantly enhanced moisture-carrying capacity compared with the ambient air. Therefore, moisture is absorbed, evaporated or otherwise captured by the drying air. The flow of drying air exiting the outlet port 39 of dehumidifier 32 is regulated by a flow control device 40 having an adjustable orifice or other variable stricture for regulating the flow rate of the air stream through the dehumidifier 32. More specifically, the flow rate through the dehumidifier 32 is regulated by flow control device 40 so that the water molecules are effectively removed so as to provide the output stream of drying air having an effectively reduced relative humidity relative to the ambient air. For example, the drying air may be depleted of water molecules to provide a dew point in the range of about −40° C. to about −45° C., which corresponds to a relative humidity of about 0.2%.

With continued reference to FIGS. 1 and 2, the dehumidifier 32 has a membrane cartridge or membrane separator 42 having a plurality of hollow fiber membranes 41 operative to separate water molecules from the stream of pressurized moisture-laden air received from compressor 28 and thereafter expel the water molecules from the membrane separator 42 as water vapor or liquid condensate. The hollow fiber membranes 41 are formed of any material that is selectively permeable to water molecules. The stream of moisture-laden ambient air from compressor 28 is conveyed through the hollow portion of each fiber membrane 41 from the inlet port 33 toward the outlet port 39 of the membrane separator 42. Water molecules entrained in the stream received from the compressor 28 permeate through the hollow fiber membranes 41 and are removed from the stream. The hollow fiber membranes 41 are arranged in the membrane separator 42 so the air stream flowing through the dehumidifier 32 cannot bypass the action of the hollow fiber membranes 41 during flow between the inlet and outlet ports 33, 39 of the membrane separator 42. Water molecules permeating through the hollow fiber membranes 41 aggregates as moisture and drains from the membrane separator 42 through a weep hole 43 for disposal.

It is appreciated that the membrane separator 42 may be adapted for removing gaseous components, in addition to water molecules, from the ambient air stream received from compressor 28 so that the drying air is depleted of that gaseous component relative to the concentration of the gaseous component in the ambient air received from compressor 28. For example, in drying systems of the invention adapted to remove moisture from corrosion-sensitive articles such as electronic components, the invention contemplates adapting the membrane separator 42, such as by applying a suitable coating to the hollow fiber membranes 41, to remove oxygen molecules as well as water molecules from the ambient air stream received from compressor 28.

Fabric treatment chemicals, such as fabric softeners, anti-static agents and other fabric conditioners, may be provided by a dispenser 44 coupled in fluid communication with air passageway 23. The fabric treatment chemical would be entrained in the drying air and conveyed to the chamber 20. The flow of the fabric treatment chemical from the dispenser 44 to the air passageway 23 may be regulated or otherwise metered by a flow control device 46, such as a conventional valve.

With continued reference to FIGS. 1 and 2, drying air from the dehumidifying system 22 is directed into receptacle 12 through air passageway 23, through the inlet 24 into the chamber 20, through the chamber 20, and into an outlet 48 provided in the stationary rear wall 26 of receptacle 12. A continuous flow of drying air is provided from the inlet 24 through the chamber 20 to the outlet 48 for removing moisture from the fabric articles therein by evaporative processes. The drying air has a moisture-carrying capacity due to its reduced dew point and becomes moisture-laden with the evaporated moisture. The stream of moisture-laden drying air and is exhausted from the chamber 20 via outlet 48. A lint filter 52 disposed in the air passageway 51 is operative for trapping and holding lint and other air bourne particles originating from the articles and the stream of moisture-laden drying air. The moisture-laden drying air is directed through an air passageway 54 to the exterior of the outer cabinet 14. The flow of drying air and entrained moisture into the outlet 48 and air passageway 52 may be assisted by a fan or blower 50 positioned within outer cabinet 14 and coupled in fluid communication with the outlet 48 by an air passageway 51. However, it is appreciated that the pressurized flow of drying air from the dehumidifier 32 may suffice to provide an adequate flow.

A control system 56 (FIG. 2) is provided for controlling the operation of the various components of the dryer 10. The control system 52 includes the necessary conventional electromechanical and/or electronic components as understood by persons of ordinary skill required to operate the dryer 10. The dryer 10 may include a humidity sensor 58 (FIG. 2) operative to sample the environment inside chamber 20, generate a signal representative of the percent relative humidity of air flowing through the dryer 10 during operation, and provide the signal to the control system 56. Humidity sensor 58 may be any humidity sensor generally known in the art, and the invention is not limited to practice with any one particular type of humidity sensor. The control system 56 is also electrically coupled with, and controls the operation of, the motor 16, the compressor 28, the dispenser 44, and the blower 50, if present. A user interface 60 is provided for inputting a set of desired drying conditions to the control system 56.

In another alternative aspect of the invention, the dryer 10 may be provided with a heater 62 powered by gas, steam or an electric heating element. The heater 62 may be used to heat the dehumidified air, either before the dehumidified air enters the chamber 20 of receptacle 12 or before the ambient air from the compressor 28 is provided to the inlet port 33 of the membrane separator 42. The heater 62 operates generally to supplement the drying effect of the dehumidification of the drying air. It is appreciated that the reduced relative humidity of the air provided to the chamber 20 of the receptacle 12 during a drying operation, according to the principles of the invention, permits the heater 62 to provide a significantly reduced amount of heat for successfully drying the clothes and, as a result, the dryer 10 will consume less electrical power. It is further appreciated that, according to the principles of the invention, the utilization of heater 62 is optional and that heating of the drying air is not required before supplying the drying air to the chamber 20. Operation of the heater 62 may be limited to periods in the drying cycle for the articles during which heated drying air is required, for example, to remove wrinkles from certain types of fabric articles.

The principles of the invention may be adapted for removing moisture from articles other than fabric articles as will be appreciated by persons of ordinary skill in the art. For example, the dehumidifier 32 may be coupled in fluid communication with a non-rotating receptacle (not shown) for supplying drying air to remove the moisture from wetted articles, such as dishes or electronic components, held in a chamber of the receptacle, similar to chamber 20.

In another aspect, the dryer 10 may be provided with one or more electrostatic elements 64 positioned in the air flow path through the chamber 20. The electrostatic elements 64 are typically positioned near the inlet 24 and/or the outlet 48 provided in the stationary rear wall 26 of receptacle 12. The electrostatic elements 64 are operative to attract or repel moisture and/or particulate contamination in the stream of drying air. Various types of media are commercially available for use in the electrostatic elements and, preferably, the electrostatic elements 64 are made of a self-charging electrostatic filter material such as a woven polypropylene.

In yet another aspect and with reference to FIG. 1, the air passageway 23 of dryer 10 may be provided with a vortex impeller 25 positioned near inlet 24. The vortex impeller 25 is a stationary structure including a plurality of vanes or blades angularly distributed about a shared central attachment point. The vanes of the vortex impeller 25 disrupt the flow of drying air and impart a cyclonic component to the drying air flowing from the inlet 24 into the chamber 20, which assists in the drying action occurring in chamber 20 removing moisture from the fabric articles therein.

In use and with reference to FIGS. 1 and 2, the cabinet door 18 is opened, wet fabric articles are inserted into the chamber 20 of the receptacle 12, and the cabinet door 18 is closed. The user selects a desired dryness or, alternatively, an appropriate drying time via the user interface 60. The control system 56 responds to these selections by energizing at least the motor 16, the compressor 28, and the blower 50, if present, in order to initiate a drying cycle. The motor 16 turns the receptacle 12 to tumble the wet articles during the drying cycle. The compressor 28 intakes moisture-laden air from the surrounding ambient atmosphere through air intake 30 and provides a pressurized flow of moist ambient air to the inlet port 33 of the dehumidifier 32. The dehumidifier 32 removes water molecules from the flow of moisture-laden air and outputs a stream or flow of drying air from outlet port 39 having an increased capacity to receive and entrain moisture. The stream of drying air is substantially free of any heat added by the drying process because the use of dehumidifier 32 eliminates the need to heat the drying air to accomplish moisture removal from the wet fabric articles. The sole source of heat would relate to heating of the moist ambient air provided to the dehumidifier 32 due to the operation of the compressor 28.

The drying air exiting the dehumidifier 32 is directed into the inlet 24 of the receptacle 12. For drying fabric articles, dispenser 44 may supply a fabric treatment chemical to the stream of drying air that is injected between dehumidifier 32 and inlet 24. The drying air envelopes and permeates the tumbling fabric articles and provides an atmosphere inside chamber 20 capable of effectively and efficiently removing water from the wet fabric articles by evaporation. To that end, the rate of water evaporation from the fabric articles is higher than that of moisture absorption into the fabric articles in the atmosphere of chamber 20. The moisture-laden air exiting the receptacle 12 through the outlet 48 passes through the lint filter 52 to filter out lint and other particles and then is exhausted from the dryer 10 to the surrounding ambient atmosphere. The blower 50, if present, aids in inducing a forced air flow from the inlet 24 to the outlet 48. Typically, the exhausted air is vented outside of the building in which the dryer 10 is sited.

With reference to FIG. 3 in which like reference numerals refer to like features in FIG. 2, another embodiment of a dehumidifier 32a suitable for use with dryer 10 (FIG. 1) is illustrated. The dehumidifier 32a operates by pressure swing adsorption and generally includes a pair of adsorbent columns 70, 72 each having an enclosed cavity filled with an adsorbent material 74. The two adsorbent columns 70, 72 are alternately cycled so that, while the adsorbent material 74 in column 70, for example, is drying the stream or flow of moisture-laden ambient air or other gas provided by compressor 28, the adsorbent material 74 in column 72 is being purged of accumulated moisture by a flow of drying air originating from column 70. The adsorbent material 74 is any material capable of removing moisture from an airflow, such as, for example, activated alumina-based adsorbents, anhydrous calcium sulfate, silica gels, molecular sieves, zeolites, and non-zeolite molecular sieves, operable to remove moisture from the flow of moisture-laden ambient air and capable of continued moisture removal associated with repeated pressure swing cycling.

Flow control devices 76, 77 are provided in air passageway 35 between the compressor 28 and the columns 70, 72 and flow control devices 78, 79 are provided in air passageway 23 between the columns 70, 72 and the receptacle 12. In addition, flow control devices 80, 81 are provided in a common vent line 84 extending from the dryer 10 to the ambient environment and a purge line 86 interconnects the output sides of the columns 70, 72. The relative positions of flow control devices 76-81 determine which of the columns 70, 72 is operating by receiving the flow of moisture-laden ambient air from the compressor 28 and providing the flow of drying air to the chamber 20, and which of the columns 70, 72 is being regenerated by drying air originating from the operating one of columns 70, 72. Specifically, when column 70 is cycled to provide drying air to chamber 20, devices 76, 78, and 81 are opened and devices 77, 79 and 80 are closed. Humid ambient air pumped from the compressor 28 is admitted into column 70. The adsorbent material 74 in column 70 removes moisture from the flowing air so as to generate the stream of drying air provided to chamber 20.

A portion of the drying gas from column 70 is diverted into the output side of column 72 and reverse flows as a purge gas through the adsorbent material 74 in column 72 toward the input side. The drying gas from column 70 removes and entrains moisture held by the adsorbent material 74 of column 72. The drying gas and moisture are exhausted through the vent line 84. When column 72 is cycled to provide drying air to chamber 20, the positions of valves 76-81 are reversed so that column 70 is regenerated. This cyclic mode of operation that alternates columns 70, 72 enables dehumidifier 32a to supply a continuous flow of drying air to the chamber 20.

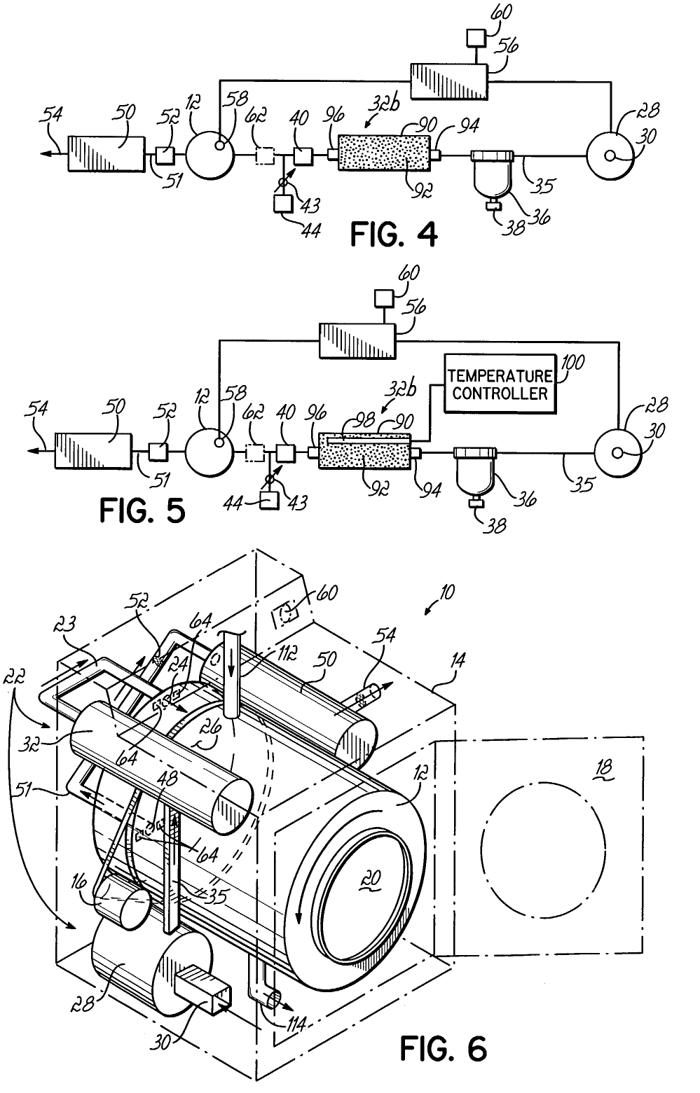

With reference to FIG. 4 in which like reference numerals refer to like features in FIG. 2, another embodiment of a dehumidifier 32b suitable for use with dryer 10 (FIG. 1) is illustrated. The dehumidifier 32b generally includes a desiccant container 90 filled with an adsorbent material 92, an inlet port 94 provided in the desiccant container 90 and an outlet port 96 also provided in the desiccant container 90. Moisture-laden ambient air or gas provided from compressor 28 enters the inlet port 94, flows through the interconnected porosity of the adsorbent material 92 for dehumidification, and exits through the outlet port 96 as drying air which is directed to the chamber 20 of receptacle 12 (FIG. 1). The adsorbent material 92 is operative to remove water molecules from the stream of the moisture-laden ambient air entering the inlet port 94 and to discharge a stream of drying air from the outlet port 96.

The adsorbent material 92 disposed inside the desiccant container 90 may be any material exhibiting a strong surface affinity for water, thereby providing the capability for separating water from the stream or flow of air or other gas provided to dryer 10. The adsorbent material 92 should be capable of attractively holding the separated water without substantial re-release until the adsorbent material 92 is saturated and no longer effective for water removal. Suitable conventional water-adsorbing materials for use as adsorbent material 92 include, but are not limited to, activated alumina-based adsorbents, anhydrous calcium sulfate, silica gels, molecular sieves, zeolites, and non-zeolite molecular sieves. The adsorbent material 92 may be any one of these materials used individually or an appropriate combination of two or more materials. The adsorbent material 92 may assume any of various forms, including filters, fibers, meshes, spheres, pellets, lattices, rods, pleats, and other forms apparent to persons of ordinary skill in the art, having sufficient interconnecting porosity to facilitate air flow through the adsorbent material 92 without precipitating a significant pressure drop. It is appreciated that the adsorbent material 92 may exhibit a strong surface affinity for gaseous components in addition to water molecules in the air stream received from compressor 28. For example, the adsorbent material 92 may be a molecular sieve material also having an affinity for oxygen molecules for those drying applications in which oxygen can cause corrosion of the articles being dried.

Molecular sieve adsorbents and silica gels suitable for use in the invention are commercially available, for example, from the Davison Chemicals Division of W. R. Grace & Co. (Columbia, Md.). Alumina-based adsorbents suitable for use in the invention are commercially available from, for example, the Alcoa Adsorbents & Catalysts Division of Alcoa World Chemicals (Leetsdale, Pa.). Calcium sulfate adsorbents suitable for use in the invention are commercially available, for example, under the DRIERITE® tradename from W. A. Hammond Drierite Co. Ltd. (Xenia, Ohio).

The adsorbent material 92 has a finite holding capacity for water molecules and eventually becomes saturated or ineffective as the holding capacity is approached with successive operations of the dryer 10. When saturation occurs, the spent adsorbent material 92 may simply be replaced with fresh adsorbent material 92 when the dryer 10 is not operating.

In an alternative embodiment and with reference to FIG. 5 in which like reference numerals refer to like features in FIG. 4, the desiccant container 90 is equipped with a heating element 98. The heating element 98 is any device operative to heat the adsorbent material 92 confined inside the desiccant container 90 to a temperature and for a time sufficient to desorb accumulated moisture. For example, the heating element 98 may be a resistive heating element. The vaporized water molecules escape from the desiccant container 90 by a vent (not shown). The heating cycle thermally regenerates the spent adsorbent material 92, which is reused in dehumidifier 32b following regeneration. A temperature controller 100 is provided for electrically energizing and controlling the operation of the heating element 98. The temperature controller 100 is any suitable conventional temperature controller operative for providing electrical energy to a heating element.

With reference to FIG. 6 in which like reference numerals refer to like features in FIG. 1 and according to an alternative embodiment of the invention, an appliance 110 includes the features of 10 and is further equipped with a liquid inlet 112 and a drain 114 so that the appliance 110 also serves as a front-loading washing machine for the fabric articles. As a result, both operations can be performed in a single device and without transferring the wet fabric articles from a conventional washing machine to a conventional dryer. The liquid inlet 112 and drain 114 each have one end coupled in fluid communication with chamber 20 of receptacle 12. An opposite end of the liquid inlet 112 is coupled in fluid communication with a source of a cleansing liquid, such as water. An opposite end of the drain 114 extends to a disposal system for disposing of the liquid drained from the chamber 20. The user interface 60 is used to input a desired wash cycle into the control system 56. Control system 56 is operative for controlling the operation of the appliance 110 during the wash cycle, as well as the drying cycle. It is appreciated that the inlet 24 and the outlet 48 are each blocked by a suitable flow control device (not shown) during a wash cycle.

In use, the cabinet door 18 is opened, articles are introduced into the chamber 20 of the receptacle 12, and the cabinet door 18 is closed. The user selects a desired wash cycle via the user interface 60. The control system 56 responds to these selections by controlling the flow of liquid into chamber 20 through liquid inlet 112, the draining of liquid from chamber 20 through drain 114, and energizing the motor 16 in a sequence appropriate to accomplish the wash cycle. The motor 16 turns the receptacle 12 at a given rotation rate or angular velocity suitable to tumble the articles to provide a cleaning action. The motor 16 turns the receptacle 12 at a different rotation rate suitable to spin dry the wet or moist articles in preparation for a drying cycle. The drying cycle for the moist articles washed in the receptacle 12 is then accomplished by appliance 110 as described above with regard to FIGS. 1 and 2.

A drying system or dryer constructed according to the principles of the invention has a significantly improved efficiency of operation yet exhibits a drying capability comparable to a conventional dryer. Because of the improved efficiency, the drying system or dryer of the invention will consume less electrical energy than conventional dryers equipped with a conventional heater alone. In certain embodiments of the invention, power is consumed only by the electric motor driving rotation of the receptacle, if rotatable, and the blower drawing air through the chamber of the receptacle. For drying fabric articles, rotation of the receptacle tumbles the fabric articles while operating the drying system to provide a flow of drying air or gas to the chamber of the receptacle. The drying gas has an enhanced moisture-carrying capacity due to its relatively low dew point.

A drying system or dryer constructed according to the principles of the invention does not require 220 VAC or a gas supply to power a heater. In addition, the amount of heat generated by the operation of the drying system or dryer of the invention will be significantly reduced because of the elimination of the heater. Therefore, the heat load added to the environment of the building housing the drying system or dryer will be reduced. The drying system or dryer of the invention will also improve the control over the drying process. Moreover, because a heater is not required, the drying system or dryer eliminates the hazards associated with a heating element, such as flammability.

A dryer constructed according to the principles of the invention preserves the structure of the fabric articles being dried by eliminating the need to heat the drying air. In particular, fabric articles suffer less stress from the drying process and will have an extended wearable lifetime. Furthermore, fabric articles prone to shrinkage when exposed to heated air will benefit from the invention because of the substitution of dehumidified drying air, according to the principles of the invention, for heated drying air found in conventional clothes dryers. Generally, because fabric articles are dried at a significantly lower temperature, the constituent materials of the fabric articles being dried do not have to be heat resistant. In particular, heat intolerant fabric articles may be dried in the dryer of the invention.

While the invention has been illustrated by a description of various preferred embodiments and while these embodiments have been described in considerable detail in order to describe the best mode of practicing the invention, it is not the intention of the applicants to restrict or in any way limit the scope of the appended claims to such detail. Additional advantages and modifications within the spirit and scope of the invention will readily appear to those skilled in the art. The invention itself should only be defined by the appended claims, wherein we claim:

1. A dryer for drying articles, comprising:
a drying chamber configured to hold articles, an inlet to said drying chamber, and an outlet from said drying chamber; and
a drying gas source coupled in fluid communication with said inlet, said drying gas source including a membrane separator configured to remove moisture from drying gas to be provided to said inlet such that said drying gas is operable for absorbing moisture from articles in said drying chamber to be subsequently exhausted with the moisture from said drying chamber through said outlet.

2. The dryer of claim 1 wherein said drying gas source further comprises a compressor operative to supply a flow of a gas to said membrane separator for generating the drying gas.

3. The dryer of claim 1 further comprising an electrostatic element positioned proximate to at least one of said inlet and said outlet of said drying chamber.

4. The dryer of claim 1 wherein said drying gas source further comprises a dispenser operative to supply a fabric treatment chemical to the drying gas provided to said inlet.

5. The dryer of claim 1 wherein said drying gas source further comprises a heater operative to heat the drying gas provided to said inlet.

6. The dryer of claim 1 wherein said drying gas source further comprises a heater operative to heat the drying gas provided to said membrane separator.

7. The dryer of claim 1 wherein said drying gas source is operable to provide drying gas to said inlet that is substantially free of added heat.

8. The dryer of claim 1 further comprising a humidity sensor operative to sample the environment inside said drying chamber and to generate a signal representative of the percent relative humidity of drying gas flowing from said inlet to said outlet.

9. The dryer of claim 1 wherein said drying chamber is adapted to be rotated about an axis.

10. The dryer of claim 1 wherein said membrane separator is further operative to remove oxygen from the drying gas to be provided to said inlet.

11. The dryer of claim 1 further comprising a blower coupled in fluid communication with said outlet, said blower operative to promote a flow of drying gas through said drying chamber from said inlet to said outlet.

12. The dryer of claim 1 further comprising a vortex impeller operative to disrupt drying air flowing out of said inlet into said drying chamber.

13. A dryer for drying articles, comprising:
a drying chamber configured to hold articles, an inlet to said drying chamber, and an outlet from said drying chamber; and
a drying gas source coupled in fluid communication with said inlet, said drying gas source including an adsorbent material configured to remove moisture from drying gas to be provided to said inlet such that said drying gas is operable for absorbing moisture from articles in said drying chamber to be subsequently exhausted with the moisture from said drying chamber through said outlet.

14. The dryer of claim 13 wherein said drying gas source further includes a regenerating device operative to selectively desorb moisture adsorbed by said adsorbent material.

15. The dryer of claim 13 wherein said adsorbent material is selected from the group consisting of alumina-based adsorbents, anhydrous calcium sulfate, silica gels, molecular sieves, zeolites, and non-zeolite molecular sieves.

16. The dryer of claim 13 wherein said adsorbent material is distributed among at least two containers configured to be alternatingly coupled in fluid communication with said inlet of said drying chamber.

17. The dryer of claim 16 wherein said adsorbent material is selected from the group consisting of alumina-based adsorbents, anhydrous calcium sulfate, silica gels, molecular sieves, zeolites, and non-zeolite molecular sieves.

18. The dryer of claim 13 wherein said drying gas source further comprises a compressor operative to supply a flow of a gas to said adsorbent material.

19. The dryer of claim 13 further comprising an electrostatic element positioned proximate to at least one of said inlet and said outlet of said drying chamber.

20. The dryer of claim 13 wherein said drying gas source further comprises a dispenser operative to supply a fabric treatment chemical to the drying gas provided to said inlet.

21. The dryer of claim 13 wherein said drying gas source further comprises a heater operative to heat the drying gas provided to said inlet.

22. The dryer of claim 13 wherein said drying gas source further comprises a heater operative to heat the drying gas provided to said adsorbent material.

23. The dryer of claim 13 wherein said drying gas source is operable to provide drying gas to said inlet that is substantially free of added heat.

24. The dryer of claim 13 further comprising a humidity sensor operative to sample the environment inside said drying chamber and to generate a signal representative of the percent relative humidity of drying gas flowing from said inlet to said outlet.

25. The dryer of claim 13 wherein said drying chamber is adapted to be rotated about an axis.

26. The dryer of claim 13 wherein said adsorbent material is further operative to remove oxygen from the drying gas to be provided to said inlet.

27. The dryer of claim 13 further comprising a blower coupled in fluid communication with said outlet, said blower operative to promote a flow of drying gas through said drying chamber from said inlet to said outlet.

28. The dryer of claim 13 further comprising a vortex impeller operative to disrupt drying air flowing out of said inlet into said drying chamber.

29. An appliance for cleaning articles, comprising:
a receptacle having a drying chamber adapted to hold the articles, a gas inlet to said drying chamber, and a gas outlet from said drying chamber;
a liquid inlet configured to selectively deliver cleansing liquid to said drying chamber;
a drain operative to selectively remove cleansing liquid from said drying chamber; and
a drying gas source coupled in fluid communication with said gas inlet, said drying gas source configured to remove moisture from drying gas provided to said gas inlet such that said drying gas is operable for absorbing cleansing fluid and moisture from articles in said drying chamber to be subsequently exhausted with the moisture and cleansing fluid from said drying chamber through said outlet.

30. The appliance of claim 29 wherein said receptacle is adapted to be rotated about an axis.

31. The appliance of claim 29 wherein a blower is coupled in fluid communication with said gas outlet of said receptacle.

32. The appliance of claim 29 wherein said drying gas source includes a membrane separator configured to remove moisture from the drying gas.

33. The appliance of claim 29 wherein said drying gas source includes an adsorbent material configured to remove moisture from the drying gas.

34. The appliance of claim 33 wherein said adsorbent material is selected from the group consisting of alumina-based adsorbents, anhydrous calcium sulfate, silica gels, molecular sieves, zeolites, and non-zeolite molecular sieves.

35. The appliance of claim 33 wherein said adsorbent material is distributed among at least two containers configured to be alternatingly coupled in fluid communication with said gas inlet of said drying chamber.

36. A method of drying articles comprising:
removing moisture from a flow of a moisture-laden gas with a membrane separator to provide a flow of a drying gas having a reduced moisture level;
directing the flow of the drying gas into a drying chamber configured for holding the articles to capture moisture from articles and the drying chamber; and
exhausting the drying gas and moisture captured from the articles by the drying gas in the drying chamber.

37. The method of claim 36 further comprising heating the drying gas before the flow of the drying gas is directed into the drying chamber.

38. The method of claim 36 further comprising heating the moisture-laden gas before the moisture is removed.

39. The method of claim 36 further comprising supplying a fabric treatment chemical to the drying gas flowing to the drying chamber.

40. The method of claim 36 further comprising supplying cleansing liquid to the drying chamber to mix with the fabric articles, and draining the cleansing liquid from the drying chamber before the steps of removing, directing and exhausting.

41. The method of claim 36 further comprising removing oxygen from the flow of the moisture-laden gas so that the drying gas provided to the drying chamber has a reduced oxygen level.

42. A method of drying articles comprising:
removing moisture from a flow of a moisture-laden gas with an adsorbent material to provide a flow of a drying gas having a reduced moisture level;
directing the flow of the drying gas into a drying chamber configured for holding the articles to capture moisture from the articles and the drying chamber; and
exhausting the drying gas and moisture captured from the articles by the drying gas in the drying chamber.

43. The method of claim 42 further comprising heating the drying gas before the flow of the drying gas is directed into the drying chamber.

44. The method of claim 42 further comprising heating the moisture-laden gas before the moisture is removed.

45. The method of claim 42 further comprising supplying a fabric treatment chemical to the drying gas flowing to the drying chamber.

46. The method of claim 42 further comprising supplying cleansing liquid to the drying chamber to mix with the fabric articles, and draining the cleansing liquid from the drying chamber before the steps of removing, directing and exhausting.

47. The method of claim 42 further comprising removing oxygen from the flow of the moisture-laden gas so that the drying gas provided to the drying chamber has a reduced oxygen level.
